(19) United States
(12) Patent Application Publication
(10) Pub. No.: US 2013/0141381 A1
(43) Pub. Date: Jun. 6, 2013

(54) Surface Coverage Touch

(71) Applicants: Esat Yilmaz, Santa Cruz, CA (US); Leo Merken, Palo Alto, CA (US)

(72) Inventors: Esat Yilmaz, Santa Cruz, CA (US); Leo Merken, Palo Alto, CA (US)

(21) Appl. No.: 13/309,042

(22) Filed: Dec. 1, 2011

(51) Int. Cl. G06F 3/044

(52) U.S. Cl. 345/174

(57) ABSTRACT

In one embodiment, a method includes receiving, from a touch sensor of a device, signals corresponding to touch or proximity inputs within a touch-sensitive area of the touch sensor. The touch-sensitive area has periphery areas. The method also includes determining, based on the signals, whether the touch or proximity inputs were simultaneously sensed within the periphery areas; and if the touch or proximity inputs were simultaneously sensed within the periphery areas, then initiating a pre-determined function of the device.

### TECHNICAL FIELD

This disclosure generally relates to touch sensors.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive display application, the touch sensor may enable a user to interact directly with what is displayed on the screen, rather than indirectly with a mouse or touchpad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are different types of touch sensors, such as (for example) resistive touch screens, surface acoustic wave touch screens, and capacitive touch screens. Herein, reference to a touch sensor may encompass a touch screen, and vice versa, where appropriate. A capacitive touch screen may include an insulator coated with a substantially transparent conductor in a particular pattern. When an object touches or comes within proximity of the surface of the capacitive touch screen, a change in capacitance may occur within the touch screen at the location of the touch or proximity. A controller may process the change in capacitance to determine its position on the touch screen.

### BRIEF DESCRIPTION OF THE DRAWINGS

FIG. 1 illustrates example touch sensor with an example controller.

FIG. 2 illustrates an example device with the example controller and touch sensor of FIG. 1.

FIG. 3 illustrates an example touch sensitive area with corner areas.

FIG. 4 illustrates an example touch sensitive area with edge areas.

FIG. 5 illustrates an example method for initiating a pre-determined function of a device.

### DESCRIPTION OF EXAMPLE EMBODIMENTS

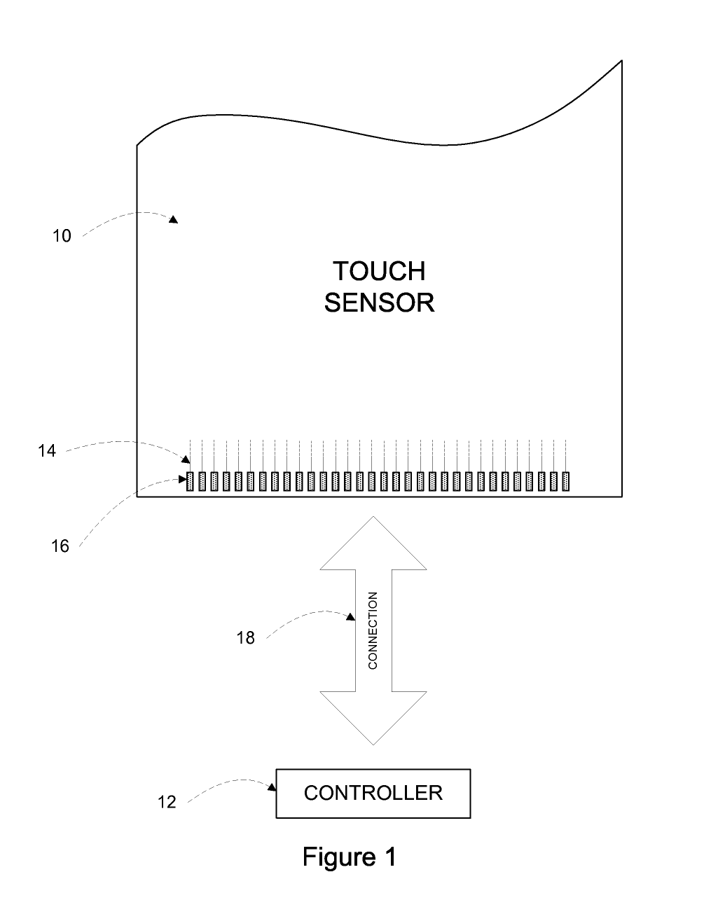

FIG. 1 illustrates an example touch sensor 10 with an example controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape, where appropriate. In particular embodiments, the conductive material of an electrode may occupy substantially less than 100% of the area of its shape. As an example and not by way of limitation, an electrode may be made of fine lines of metal or other conductive material (such as for example copper, silver, or a copper- or silver-based material) and the fine lines of conductive material may occupy substantially less than 100% of the area of its shape in a hatched, mesh, or other suitable pattern. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fills having any suitable patterns. Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 millimeter (mm); the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 microns (μm) or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs) or digital signal processors (DSPs)) of a device that includes touch sensor 10 and touch-sensor controller 12, which may respond to the touch or proximity input by initiating a function of the device (or an application running on the device) associated with it. Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

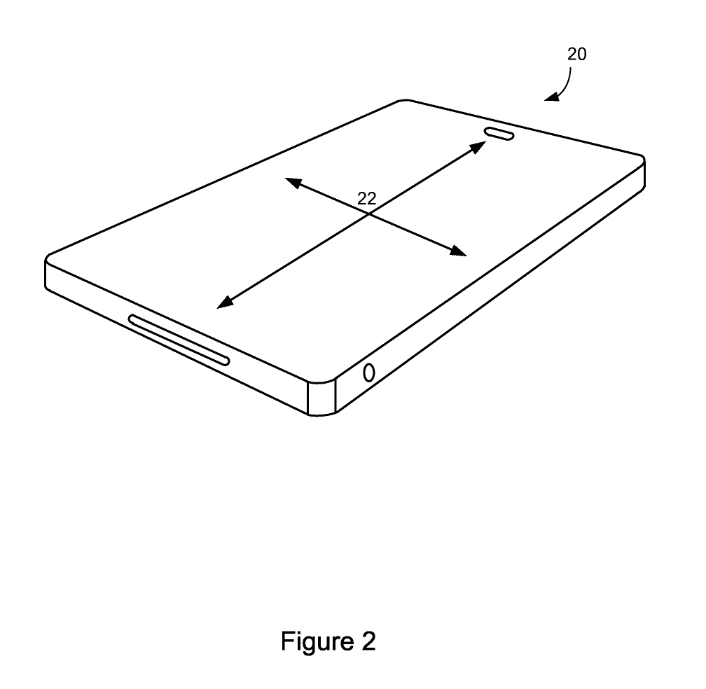

FIG. 2 illustrates an example device with the example controller and touch sensor of FIG. 1. As an example and not by way of limitation, device 20 may include a smartphone, a personal-digital assistant (PDA), a tablet computer, a laptop computer, a desktop computer, a kiosk computer, a satellite navigation device, a portable media player, a portable game console, a point-of-sale device, another suitable device, a suitable combination of two or more of these, or a suitable portion of one or more of these. In the example of FIG. 2, device 20 includes a touch sensor with a touch-sensitive area 22 proximate to a surface of device 20. As described above, the controller may process measurement signals to detect the presence and location of one or more touch or proximity inputs within touch-sensitive area 22. Moreover, the controller may process and interpret a “substantially complete surface touch”, which may be touch or proximity inputs that are substantially simultaneously sensed in multiple locations within touch-sensitive area 22, to initiate pre-determined functions executed by device 20.

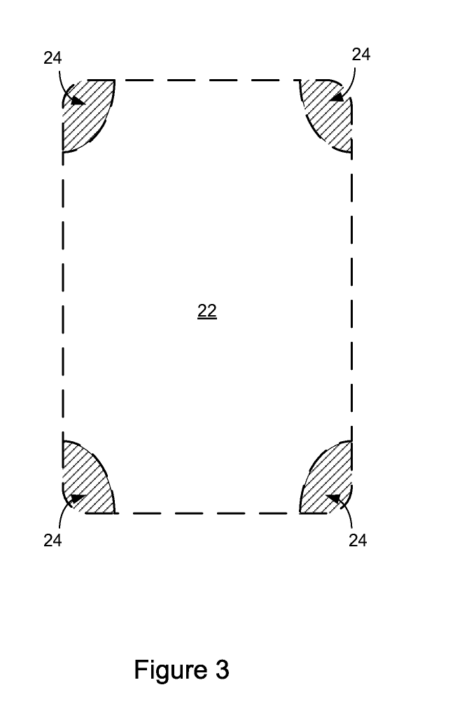

FIG. 3 illustrates an example touch sensitive area with corner areas. As described above, the controller of the device may detect a touch or proximity input sensed within touch-sensitive area 22. As an example and not by way of limitation, swiping or pinching gestures may initiate one or more pre-determined functions such as moving an object between two points or zooming in on an image on a display of the device, respectively. In particular embodiments, the controller may detect and associate a substantially complete surface touch with particular pre-determined functions to be executed by the device, as described below. As an example and not by way of limitation, the user may perform a substantially complete surface touch by a placing a hand on touch-sensitive area 22. As another example, depending on the dielectric property of a surface, a substantially complete surface touch may be performed by placing the device face down on a supporting surface such that touch-sensitive area 22 rests on or near the supporting surface. Although this disclosure describes particular methods of performing a substantially complete surface touch, this disclosure contemplates any suitable method of performing a substantially complete surface touch.

In particular embodiments, the controller determines a substantially complete surface touch based on the location of the touch or proximity inputs. In the example of FIG. 3, touch-sensitive area 22 of the touch sensor includes one or more corner areas 24. As an example and not by way of limitation, the controller identifies a substantially complete surface touch when a touch or proximity input is substantially simultaneously sensed within two or more corner areas 24. In particular embodiments, the controller identifies a substantially complete surface touch when a touch or proximity input is substantially simultaneously sensed within two corner areas 24 on opposite sides of touch-sensitive area 22. In other particular embodiments, the controller identifies a substantially complete surface touch when a touch or proximity input is substantially simultaneously sensed within two catercorner or diagonally-opposed corner areas 24. As another example, the controller may identify a substantially complete surface touch when a touch or proximity input is substantially simultaneously sensed within three or more corner areas 24. Although this disclosure describes and illustrates particularly shaped and sized corner areas 24 of particularly shaped touch-sensitive area 22, this disclosure contemplates use of any suitable corner area of any suitably shaped touch-sensitive area for identifying a substantially complete surface touch, such as for example an area substantially located along an arc of a substantially non-rectangular touch-sensitive area.

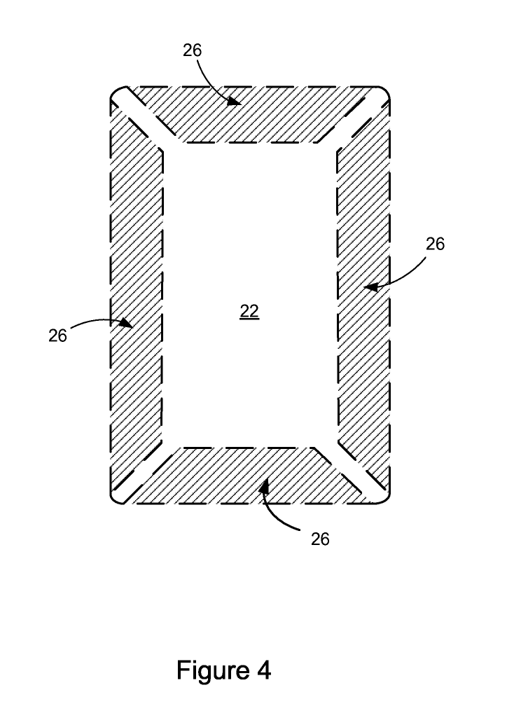

FIG. 4 illustrates an example touch sensitive area with edge areas. In the example of FIG. 4, touch-sensitive area 22 of the touch sensor includes one or more edge areas 26 with a gap separating adjacent edge areas 26. As an example and not by way of limitation, the controller identifies a substantially complete surface touch when a touch or proximity input is substantially simultaneously sensed within two or more edge areas 26. In particular embodiments, the controller identifies a substantially complete surface touch when a touch or proximity input is substantially simultaneously sensed within two non-neighboring edge areas 26 located on opposite sides of touch-sensitive area 22. As another example, the controller may identify a substantially complete surface touch when a touch or proximity input is substantially simultaneously sensed within three or more edge areas 24. Although this disclosure describes and illustrates particularly shaped and sized edge areas 26 of particularly shaped touch-sensitive area 22, this disclosure contemplates use of any suitable edge area of any suitably shaped touch-sensitive area for identifying a substantially complete surface touch, such as for example an edge area substantially located along an arc of a substantially non-rectangular touch-sensitive area.

As described above, the controller may detect and associate a substantially complete surface touch with one or more particular pre-determined functions executed by the device the controller based the touch input being substantially simultaneously sensed within two or more periphery areas. In particular embodiments, the periphery area may be corner area 24 or edge area 26. As an example and not by way of limitation, placing a hand to substantially simultaneously cover two or more periphery areas (e.g. corner areas 24 or edge areas 26) of touch-sensitive area 22 may initiate deactivating a display backlight of the device. As another example, placing touch-sensitive area 22 face down on a surface to substantially simultaneously cover two or more periphery areas (e.g. corner areas 24 or edge areas 26) may initiate locking or powering down the device, put a call in speakerphone mode, or hang up a call. Although this disclosure describes particular functions associated with the a substantially complete surface touch based on the touch or proximity input being substantially simultaneously sensed within two or more periphery areas (e.g. corner areas 24 or edge areas 26), this disclosure contemplates execution of any suitable function or any combination thereof by the device.

In particular embodiments, initiation of the pre-determined function is in response to the touch or proximity input being substantially simultaneously located within the plurality of the periphery areas for a pre-determined amount of time. In other particular embodiments, the pre-determined function initiated by determination of substantial coverage of the touch-sensitive area 22 may be reversed when the controller determines there is no longer substantial coverage of the touch-sensitive area 22. As example and not by way of limitation, picking up the device so that touch-sensitive area 22 no longer rests on the supporting surface may re-activate the display backlight of the device, return a call to handset mode, or receive a telephone call.

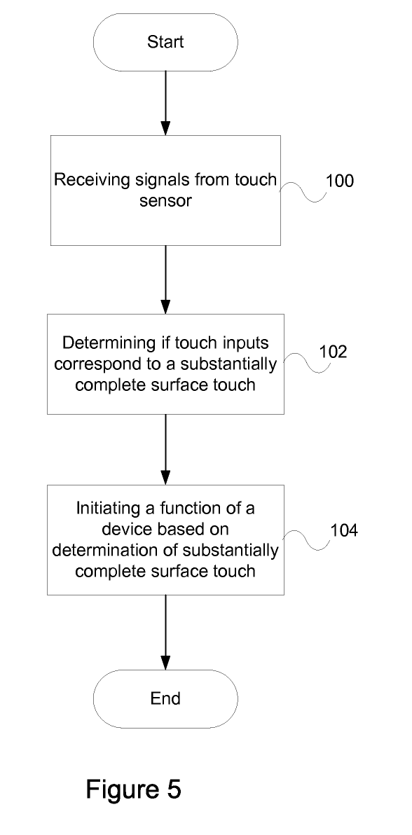

FIG. 5 illustrates an example method for initiating a pre-determined function of a device. The method starts at step 100, where a device receives one or more signals from a touch sensor corresponding to a touch or proximity input within a touch-sensitive area of the touch sensor. In particular embodiments, the touch-sensitive area may include one or more periphery areas. Step 102 determines whether the touch or proximity input is substantially simultaneously located within two or more of the periphery areas based on the received signals. In particular embodiments, two of the periphery areas used in the determining may be located opposite sides from each other. In other particular embodiments, two corner areas used in the determining may be located catercorner or diagonally opposite from each other. At step 104, a pre-determined function of the device is initiated if the touch or proximity input is substantially simultaneously sensed within at least two of the periphery areas, at which point the method may end. In particular embodiments, the pre-determined function may be deactivating the display of the device. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates particular components carrying out particular steps of the method of FIG. 5, this disclosure contemplates any suitable combination of any suitable components carrying out any suitable steps of the method of FIG. 5.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
receiving, from a touch sensor of a device, signals corresponding to touch or proximity inputs within a touch-sensitive area of the touch sensor, the touch-sensitive area having a plurality of periphery areas;
determining, based on the signals, whether the touch or proximity inputs were substantially simultaneously sensed within the plurality of the periphery areas; and
if the touch or proximity inputs were substantially simultaneously sensed within the plurality of the periphery areas, then initiating a pre-determined function of the device.

2. The method of claim 1, wherein the periphery areas comprise a corner area or an edge area.

3. The method of claim 2, wherein the determining step comprises determining whether the touch or proximity inputs were substantially simultaneously located within at least a first one of the corner areas and a second one of the corner areas that is substantially catercorner to the first one of the corner areas.

4. The method of claim 1, wherein the determining step comprises determining whether the touch or proximity inputs were substantially simultaneously located within at least a first one of the periphery areas and a second one of the periphery areas located on a side within the touch-sensitive area substantially opposite to the first one of the periphery areas.

5. The method of claim 1, wherein the determining step comprises determining whether the touch or proximity inputs were substantially simultaneously located within at least three of the periphery areas.

6. The method of claim 1, wherein the pre-determined function is one of deactivating a display backlight, locking the device, or discontinuing a phone call.

7. The method of claim 1, wherein the initiating step occurs in response to the touch or proximity inputs being substantially simultaneously located within the plurality of the periphery areas for a pre-determined amount of time.

8. A computer-readable non-transitory storage media embodying logic configured when executed to:
receive, from a touch sensor of a device, signals corresponding to touch or proximity inputs within a touch-sensitive area of the touch sensor, the touch-sensitive area having a plurality of periphery areas;
determine, based on the signals, whether the touch or proximity inputs were substantially simultaneously sensed within the plurality of the periphery areas; and
if the touch or proximity inputs were substantially simultaneously sensed within the plurality of the periphery areas, then initiate a pre-determined function of the device.

9. The media of claim 8, wherein the periphery areas comprise a corner area or an edge area.

10. The media of claim 9, wherein the logic is further configured to determine whether the touch or proximity inputs were substantially simultaneously located within at least a first one of the corner areas and a second one of the corner areas that is substantially catercorner to the first one of the corner areas.

11. The media of claim 8, wherein the logic is further configured to determine whether the touch or proximity inputs were substantially simultaneously located within at least a first one of the periphery areas and a second one of the periphery areas located on a side within the touch-sensitive area substantially opposite to the first one of the periphery areas.

12. The media of claim 8, wherein the logic is further configured to determine whether the touch or proximity inputs were substantially simultaneously located within at least three of the periphery areas.

13. The media of claim 8, wherein the pre-determined function is one of deactivating a display backlight, locking the device, or discontinuing a phone call.

14. The media of claim 8, wherein the logic is further configured to initiate the pre-determined function in response to the touch or proximity inputs being substantially simultaneously located within the plurality of the periphery areas for a pre-determined amount of time.

15. A device comprising:
a touch sensor having a touch-sensitive area, the touch-sensitive area having a plurality of periphery areas; and
a computer-readable non-transitory storage media coupled to the touch sensor and embodying logic configured when executed to:
receive, from a touch sensor of a device, signals corresponding to touch or proximity inputs within the touch-sensitive area;
determine, based on the signals, whether the touch or proximity inputs were substantially simultaneously sensed within the plurality of the periphery areas; and
if the touch or proximity inputs were substantially simultaneously sensed within the plurality of the periphery areas, then initiate a pre-determined function of the device.

16. The device of claim 15, wherein the periphery areas comprise a corner area or an edge area.

17. The device of claim 16, wherein the logic is further configured to determine whether the touch or proximity inputs were substantially simultaneously located within at least a first one of the corner areas and a second one of the corner areas that is substantially catercorner to the first one of the corner areas.

18. The device of claim 15, wherein the logic is further configured to determine whether the touch or proximity inputs were substantially simultaneously located within at least a first one of the periphery areas and a second one of the periphery areas located on a side within the touch-sensitive area substantially opposite to the first one of the periphery areas.

19. The device of claim 15, wherein the logic is further configured to determine whether the touch or proximity inputs were substantially simultaneously located within at least three of the periphery areas.

20. The device of claim 15, wherein the logic is further configured to initiate the pre-determined function in response to the touch or proximity inputs being substantially simultaneously located within the plurality of the periphery areas for a pre-determined amount of time.
